(19) United States
(12) Patent Application Publication
(10) Pub. No.: US 2019/0229580 A1
(43) Pub. Date: Jul. 25, 2019

(54) BATTERY PACK CHARGER SYSTEM

(71) Applicant: BLACK & DECKER INC., New Britain, CT (US)

(72) Inventors: Elyse EDWARDS, Aberdeen, MD (US); Matthew J. VELDERMAN, Baltimore, MD (US); William A. RIGDON, Baltimore, MD (US); Andrew E. SEMAN, Baltimore, MD (US); Daniel J. WHITE, Baltimore, MD (US)

(21) Appl. No.: 16/374,052

(22) Filed: Apr. 3, 2019

Related U.S. Application Data
(63) Continuation of application No. PCT/US2017/054715, filed on Oct. 2, 2017.
(60) Provisional application No. 62/404,057, filed on Oct. 4, 2016.

(51) Int. Cl. H02K 7/18; H02J 7/14; H02J 7/32; H02J 7/00

(52) U.S. Cl. CPC H02K 7/1815; H02J 7/1423; H02J 7/0042; H02J 7/32; H02J 7/1415

(57) ABSTRACT

A battery pack charger system includes a charger having one or more receptacles for charging one or more removable battery packs, where the charger is capable of being mounted to a rotating component of an engine. The battery pack charger system includes an alternator that is electrically coupled to the charger and that is mechanically coupled to the rotating component of the engine to generate and provide electrical power to the charger. An adapter bracket is mechanically coupled to the charger and the adapter bracket is configured to receive the alternator and to mechanically couple the alternator to the rotating component of the engine.

### CROSS REFERENCE TO RELATED APPLICATIONS

This application is a continuation of PCT Application No. PCT/US2017/054715, filed Oct. 2, 2017, which claims priority to U.S. Provisional Application No. 62/404,057, filed Oct. 4, 2016.

### TECHNICAL FIELD

This description relates to a battery pack charger system.

### BACKGROUND

Users of outdoor cordless tools discharge their battery packs faster than they can charge them. The availability of charging power sources (e.g., AC outlet, DC cigarette lighter outlet, etc.) is often unavailable or does not provide enough power and energy to keep up with demand.

### SUMMARY

In one general aspect, a battery pack charger system includes a charger having one or more receptacles for charging one or more removable battery packs, where the charger is capable of being mounted to a rotating component of an engine.

Implementations may include one or more of the following features. For example, the system may include an alternator that is electrically coupled to the charger and that is mechanically coupled to the rotating component of the engine to generate and provide electrical power to the charger. The system may include an adapter bracket that is mechanically coupled to the charger and the adapter bracket is configured to receive the alternator and to mechanically couple the alternator to the rotating component of the engine. The adapter bracket may be configured to be received in a flywheel of the engine. The rotating component of the engine may include a flywheel of a mower engine and the charger is capable of being mounted to flywheel of the mower engine. The alternator may be a brushless alternator.

In another general aspect, a battery pack charger system includes a charger having one or more receptacles for charging one or more removable battery packs and a charger mounting bracket coupled to the charger, where the charger mounting bracket is for mounting the charger to one or more engine shroud holes of an engine. The system includes an alternator that is electrically connected to the charger and that is coupled to the charger mounting bracket, where the alternator is for generating electrical power for delivery to the charger. The system includes an adaptor bracket for receiving the alternator, where the adaptor bracket is configured to be received in a flywheel of an engine and to impart rotational motion from the flywheel to the alternator.

Implementations may include one or more of the following features. For example, the removable battery packs may include lithium-ion battery packs for providing power to cordless devices. The charger mounting bracket includes one or more slots. The alternator includes a stator component and a rotor component, where the stator component is held stationary by the charger mounting bracket and the rotor component rotates with the adaptor bracket and the flywheel relative to the stator component. The system may include a bracket and a charger seating bracket, where the bracket secures the chargers to the charger seating bracket and the charger seating bracket secures the charger to the charger mounting bracket. The bracket may include one or more covers that are hingedly attached to the bracket to cover and protect the charger.

The details of one or more implementations are set forth in the accompanying drawings and the description below. Other features will be apparent from the description and drawings.

### BRIEF DESCRIPTION OF THE DRAWINGS

FIG. 1 is a perspective view of a battery pack charger system.

FIG. 2 is a side view of the battery pack charger system of FIG. 1.

FIG. 3 is an exploded view of the battery pack charger system of FIG. 1.

FIG. 4 is an example illustration of the battery pack charger system of FIG. 1 implemented on a riding mower.

FIG. 5 is a perspective view of the battery pack charger system of FIG. 1 coupled to an internal combustion engine.

FIG. 6 is a perspective view of the internal combustion engine of FIG. 5 and an uninstalled adaptor bracket from the battery pack charger system.

FIG. 7 is a top view of the internal combustion engine of FIG. 5 without the battery pack charger system.

FIG. 8 is a perspective view of an adapter bracket installed in the engine of FIG. 5 and an uninstalled alternator from the battery pack charger system.

FIG. 9 is a top view of the adapter bracket installed in the engine of FIG. 5.

FIG. 10 is a perspective view of an alternator coupled with an adapter bracket and installed in the engine of FIG. 5.

FIG. 11 is a top view of the alternator coupled with the adapter bracket and installed in the engine of FIG. 5.

FIG. 12 is a view of a top of a charger mounting bracket.

FIG. 13 is a view of a bottom of the charger mounting bracket of FIG. 12.

FIG. 14 is a perspective view of the charger mounting bracket of FIG. 12 coupled to the engine of FIG. 5.

FIG. 15 is a top view of the charger mounting bracket of FIG. 12 coupled to the engine of FIG. 5.

FIG. 16 is a perspective view of a charger seating bracket coupled to the engine of FIG. 5.

FIG. 17 is a top view of the charger seating bracket coupled to the engine of FIG. 5.

### DETAILED DESCRIPTION

This document describes systems and techniques for a battery pack charger system that is connected to a primary rotating element of an engine-powered equipment to charge one or more removable battery packs. For example, in one implementation, the battery pack charger system is connected to the flywheel of an internal combustion engine (ICE) of a riding mower to charge the removable battery packs. In other implementations, the battery pack charger system may be connected to other rotating components of the mower or to other equipment, such as other outdoor equipment like an all-terrain vehicle (ATV), including being connected to the ICE of the ATV.

The battery pack charger system includes an alternator assembly that attaches to a primary rotating element and converts the primary rotational energy into secondary charging energy. The secondary charging energy is used to charge multiple, removable battery packs, which may be used to provide power to various cordless equipment. For example, the removable battery packs may be used to provide power to cordless power tools, cordless lawn tools, cordless radios, etc. The battery pack charger system may be implemented to connect to various different equipment that includes a primary rotating element such that the same battery pack charger system may be used on different types or different brands of equipment. For example, the battery pack charger system may be attached to the primary rotating element of an outdoor riding mower, as mentioned above. In this example, the battery pack charger system includes an alternator assembly that is coupled to a flywheel of an internal combustion engine. In other example implementations, the battery pack charger system and alternator assembly may be coupled to other primary movers including the driving wheels of a vehicle or the blade belt system of a mower. Different adapter brackets for the battery pack charger system may be used to accommodate different engine geometries for different equipment, while the other components of the battery pack charger system remain the same, even if installed on different brands of equipment.

The battery pack charger system is designed to be user-friendly and simple to install by a non-professional user. For example, to install the battery pack charger system to a riding mower with a vertical shaft engine, the user simply needs to remove a rotating grass screen and a fixed grass screen from the mower and bolt the battery pack charger system to the mower using the holes previously occupied by the grass screens.

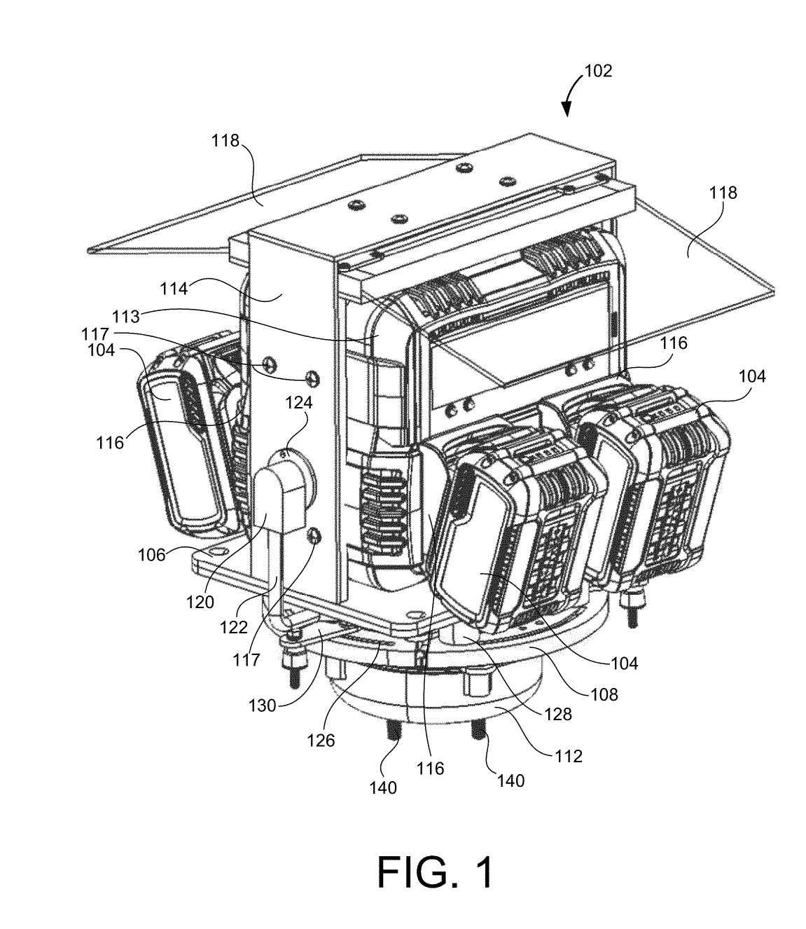

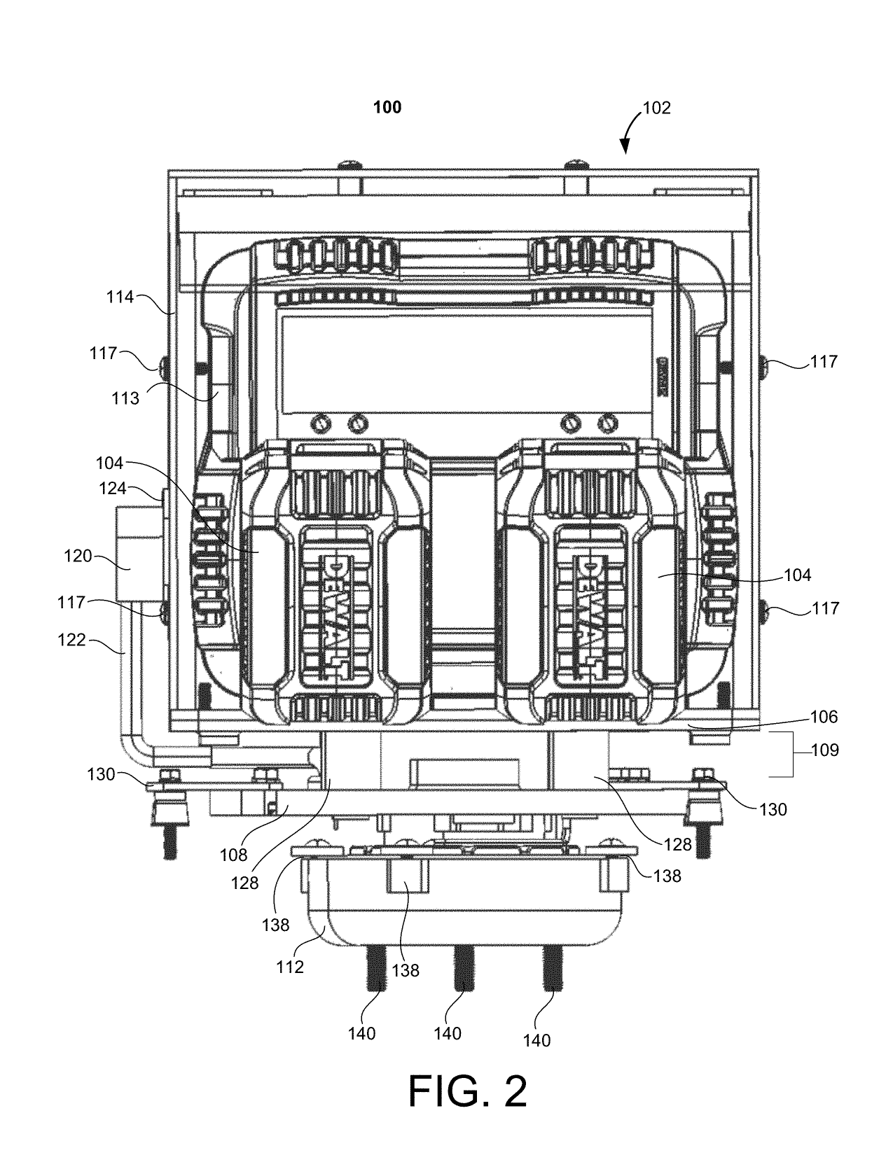

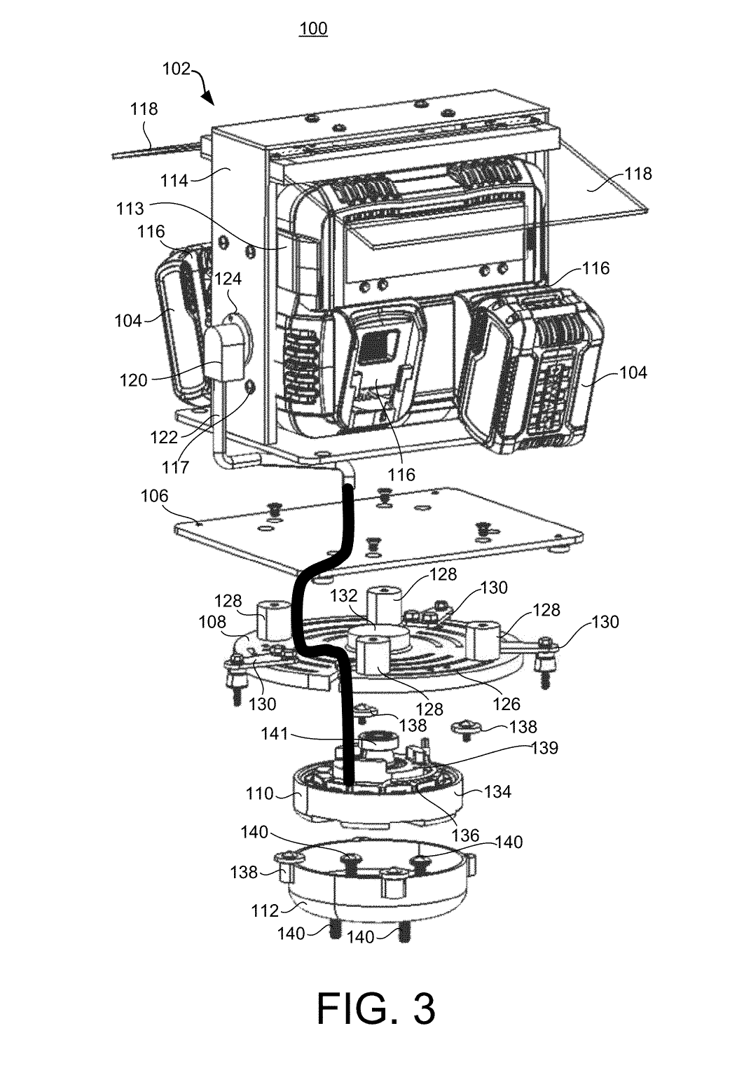

FIG. 1 is a perspective view of a battery pack charger system 100. FIG. 2 is a side view of the battery pack charger system 100 of FIG. 1. FIG. 3 is an exploded view of the battery pack charger system 100 of FIG. 1. Referring to FIGS. 1-3, the battery pack charger system 100 includes a charger 102 for charging removable battery packs 104, a charger seating bracket 106, a charger mounting bracket 108, an alternator 110 and an adapter bracket 112. The battery pack charger system 100 is capable of charging multiple battery packs 104. For example, the charger 102 may include charger electronics (not shown) located inside the charger 102 that convert an input voltage from the alternator 110 to an appropriate level, adjust the charging current and deliver power to the removable battery packs 104.

The charger 102 includes a housing 113 to support multiple charging stations 116 to interface with the removable battery packs 104. The charging stations 116 function as ports for delivering the electrical power from the charger 102 to the removable battery packs 104. Additionally, and/or alternatively, the charging stations 116 may function as receptacles for receiving an electrical connection, such as a plug, for directly connecting corded equipment to the charger 102. In this example, the housing 113 supports four charging stations 116, of which three are visibly illustrated in these figures. In other example implementations, other numbers of charging stations 116 may be included as part of the charger 102. The charger 102 and the housing 113 may support fewer or more than four charging stations 116. The charging stations 116 are capable of receiving slidable removable battery packs 104 and making electrical contact with the removable battery packs in order to provide an electrical charge from the charger 102 to the removable battery packs 104. The removable battery packs 104 may slide onto the charging stations 116 and remain secure in place while receiving a charge from the charger 102. The removable battery packs 104 may lock or snap in place to the charging stations 116.

A bracket 114 may be used to secure the charger 102 to the charger seating bracket 106. In this example, the bracket 114 includes a top portion and two side portions, where the side portions are connected to the charger seating bracket 106. The bracket 114 is secured to the housing 113 using one or more fasteners 117.

The bracket 114 includes multiple covers 118 to provide weather resistant protection to the charger 102. The covers 118 may be hingedly attached to the bracket 114 and rotate to and away from the bracket 114. The covers 118 may include a mechanism to hold the covers 118 in an open position. The covers 118 may enclose at least a portion of the housing 113 when lowered in a closed position against the housing 113. The covers 118 may provide a seal to protect the charger 102 against weather elements such as rain and wind.

The charger 102 includes an electrical connector 120, which plugs into the housing 113 to deliver electrical power through a wire 122 from the alternator 110. In this manner, electrical current generated from the alternator 110 is supplied through the wire 122 and the electrical connector 122 to the charger 102. Then, the charger 102 converts the received voltage to an appropriate output and delivers the electrical power through the charging stations 116 to charge the removable battery packs 104. In one implementation, the electrical connector 120 is a plug that couples to a receptacle 124 on the housing 113. In other implementations, the electrical connector 122 and the receptacle 124 may be other types of electrical connectors in order to deliver power from the alternator 110 to the charger 102.

In this example, the charger 102 is configured to receive 120V AC from the alternator 110. Circuitry within the charger 102 converts the received 120V AC to deliver an appropriate charging current needed by the removable battery packs 104. In this example, the removable battery packs 104 include a lithium ion battery chemistry. In other implementations, the charger 102 may be capable of receiving other types of current from the alternator 110 for any appropriate conversion and use to charge the removable battery packs 104. Also, the removable battery packs 104 may include other types of battery chemistry or energy storage devices such as super capacitors and are not limited to lithium ion battery chemistry.

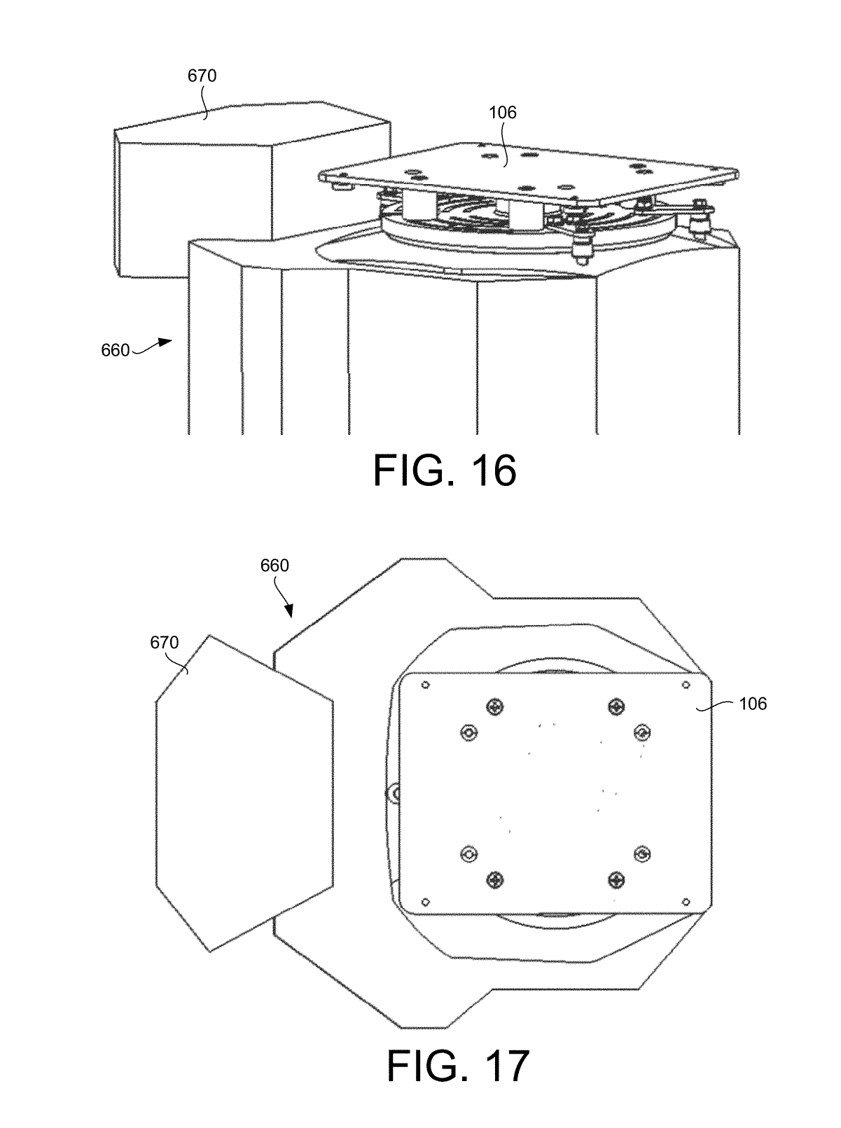

The charger 102 is secured to the charger seating bracket 106 using the bracket 114. The charger seating bracket 106 provides a platform for the charger 102. The charger seating bracket 106 is sized to accommodate the base width and length of the housing 113. In this example, the charger seating bracket 106 is rectangular in shape to match the shape of the housing 113 for the charger 102. The charger seating bracket 106 may include fastener openings that match fastener openings on the housing 113 and/or the bracket 114 so that fasteners may secure the charger 102 to the charger seating bracket 106. The charger seating bracket 106 may be made of different types of materials including metal, plastic, and/or composite materials designed to support the weight of the charger 102. FIGS. 16 and 17 below provide a further illustration of the charger seating bracket 106.

The charger 102 and the charger seating bracket 106 are coupled to the charger mounting bracket 108. A gap 109, as seen in FIG. 2, between the charger seating bracket 106 and the charger mounting bracket 108 allows air flow and cooling around the charger 102 to assist with cooling the removable battery packs 104. The charger mounting bracket 108 is separately mounted to the equipment that will provide the rotational motion to the alternator 110 to generate electrical power to charge the charger 102. For example, the charger 102 and the charger seating bracket 106 are mounted to the charger mounting bracket 108, which is then mounted to a mower. Specifically, the charger mounting bracket 108 may be mounted to a component of the mower such as the engine shroud or other part of the mower near the flywheel of the mower engine.

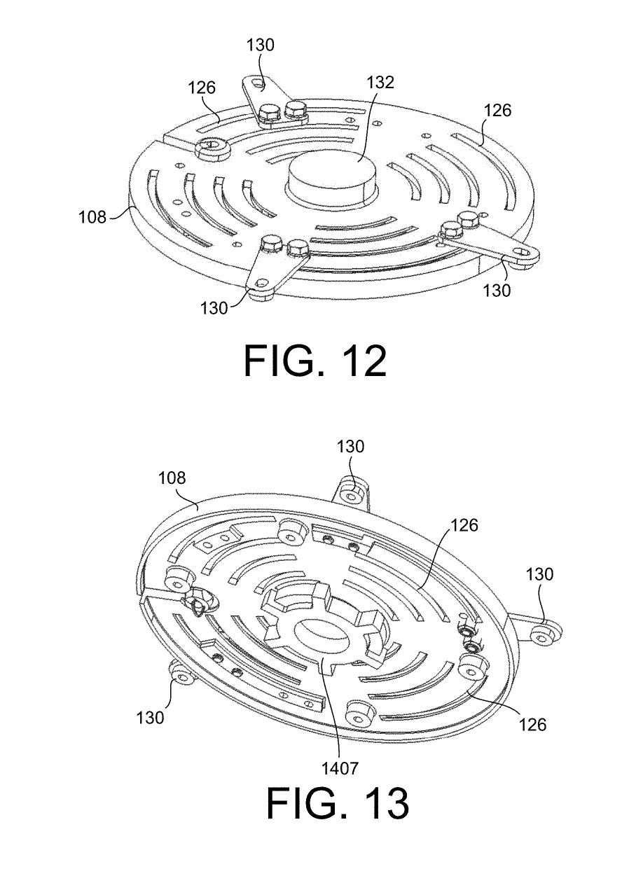

The charger mounting bracket 108 is circular-shaped disk and includes multiple openings 126 that may function as vents to enable air flow and circulation around the battery pack charger system 100. The openings 126 may be positioned around the inner circumference of the charger mounting bracket 108. The openings 126 may be positioned at various radius distances from the center of the charger mounting bracket 108. In this manner, air generated by the rotation of the engine flywheel may be vented through the openings 126 in the charger mounting bracket 108 towards the charger 102 to provide cooling for the charger 102. The charger mounting bracket 108 and the openings 126 are further illustrated and described with respect to FIGS. 12 and 13.

The charger mounting bracket 108 includes multiple compliance elements 128. The compliance elements 128 provide shock and vibration dampening between the charger mounting bracket 108 and the charger seating bracket 106. In one implementation, the compliance elements 128 are made of a rubber material. In other implementations, the compliance elements 128 may be made of other material that is capable of providing shock and vibration dampening between two components. In this example, four compliance elements 128 are illustrated. In other implementations, fewer or more compliance elements may be used.

The charger mounting bracket 108 includes multiple repositionable arms 130. The repositionable arms 130 include openings for fasteners that are used to secure the charger mounting bracket 108 to the engine shroud holes to hold the charger mounting bracket 108 stationary. The repositionable arms 130 are movable to accommodate different shroud hole locations on different types of engines. In this manner, the charger 102 may be mounted to different types of engines. The repositionable arms 130 may pivot about a point where they are fastened to the charger mounting bracket 108. The arms 130 may be moved along the openings 126 to align with the engine shroud holes. The charger mounting bracket 108 includes a bearing holder 132. The bearing holder 132 holds a bearing and receives the alternator 110 into the bearing holder 132.

The alternator 110 rotates to generate electrical current to charge the charger 102. As discussed in more detailed below, the alternator 110 is secured in the adaptor bracket 112, which in turn is secured to the flywheel of the ICE. As the flywheel rotates, the adaptor bracket 112 rotates and a rotor component 134 of the alternator 110 rotates while a stator component 136 of the alternator 110 is held fixed within the bearing holder 132 of the charger mounting bracket 108. The alternator 110 includes the stator component 136 and the rotor component 134. The rotor component 134 rotates while the stator component 136 is held stationary by the charger mounting bracket 108 with respect to the rotor component 134. The relative motion between the rotor 136 and the stator 134 generates electricity. In this example, the alternator 110 is a brushless construction. In this example, the alternator 110 generates alternating current (AC) electricity with a 120V output. In other implementations, the alternator may generate a 3-phase direct current (DC) output. The winding and magnet construction of the alternator 110 determine the type of output generated by the alternator 110. As mentioned above, the charger 102 is constructed to receive the particular electrical output generated by the alternator 110.

The alternator 110 includes a coupling 139, which is a stationary component of the stator component 136 that attaches to the bearing holder 132 of the charger mounting bracket 108. The coupling 139 holds the stator component 136 fixed within the bearing holder 132 of the charger mounting bracket 108 such that when the flywheel of the ICE, the adaptor bracket 112 and the rotor component 134 rotate, the stator component 136 remains stationary to create the relative motion between the rotor component 134 and the stator component 136. A bearing 141 is held within the bearing holder 132 and contains the rotor component 134 concentrically to the stator component 136.

In other implementations, the alternator 110 may be of any construction including, for example, field excited, brushed permanent magnet, brushless permanent magnet, or other construction. Depending on the alternator construction, there may be an intermediary electronic device to regulate the power for the charger 102. In one implementation, the alternator may be back-driven by the charger 102 to jumpstart the primary equipment.

The alternator 110 is secured inside the adapter bracket 112. The alternator 110 may include one or more keying features (not shown) to prevent the alternator 110 from slipping inside the adapter bracket 112. In this manner, the alternator 110, specifically the rotor component 134, and the adaptor bracket 112 rotate together with rotation of the flywheel. The adapter bracket 112 may include reciprocal keying features to prevent the alternator from slipping inside the adapter bracket 112. In one implementation, fasteners 138 secure the alternator 110 inside the adapter bracket 112. Then, the adapter bracket 112 is secured to the primary rotating element, such as the flywheel on a mower. The adapter bracket 112 may be secured to the primary rotating element using fasteners 140, where the fasteners 140 are bolts.

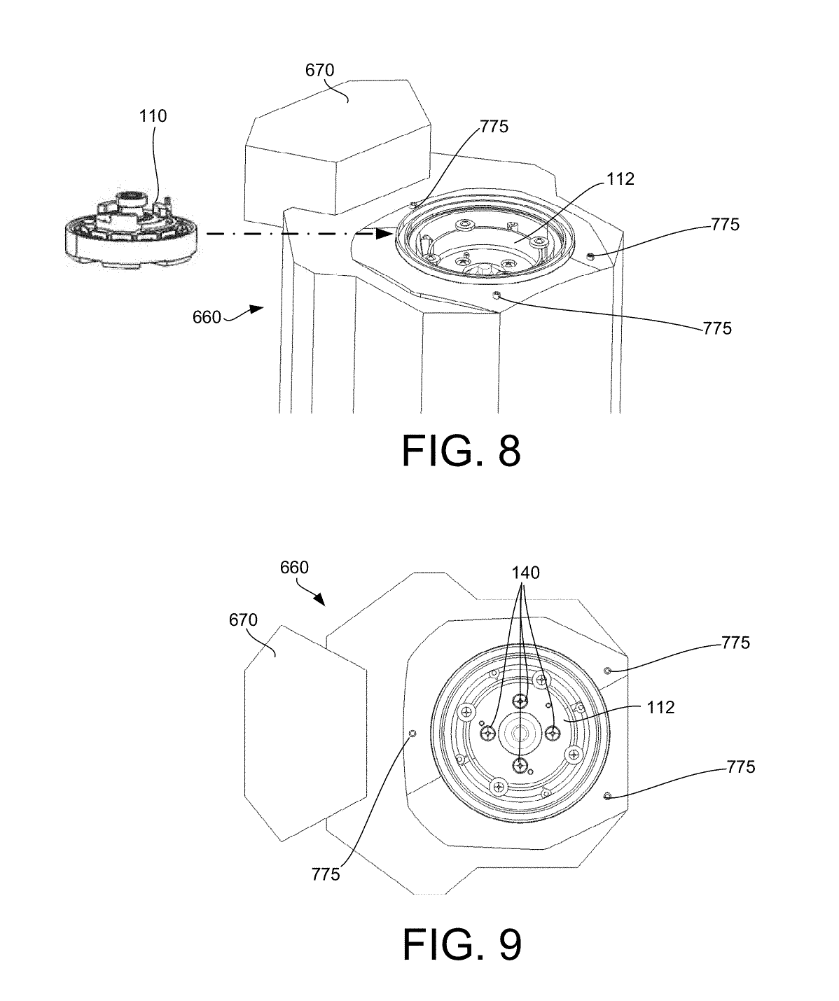

The adapter bracket 112 and the rotor component 134 of the alternator 110 rotate with the flywheel and the alternator 110 generates electrical current to charge the charger 102, which charges the removable battery packs 104. The adapter bracket 112 may vary with different engine models and include different placements of fasteners 140 and different numbers of fasteners 140 depending on the type of engine that the battery pack charger system 100 is being mounted. In this manner, different adapter brackets that are sized to fit the alternator 110 may be used depending on the type of engine that the system is being mounted to. The charger 102 may be considered a “drop-on” charger because the charger 102 may be dropped on various types of engines simply by using an adapter bracket 112 that mates with the engine flywheel holes. The engine flywheel holes typically hold a rotating grass screen that is removed to provide access to the holes. The placement of the engine flywheel holes may vary from engine model to engine model and various adapter brackets may be used to mate with particular engine models. In FIGS. 1 and 8, two fasteners 140 are visible and in FIG. 2 three fasteners 140 are visible and in FIGS. 3, 6 and 9 four fasteners are visible. In the example flywheel illustrated below with respect to FIG. 7, four flywheel holes are illustrated so the adapter bracket 112 actually includes four fasteners 140 to mate with the corresponding flywheel holes even though not all four are visible in FIGS. 1-3.

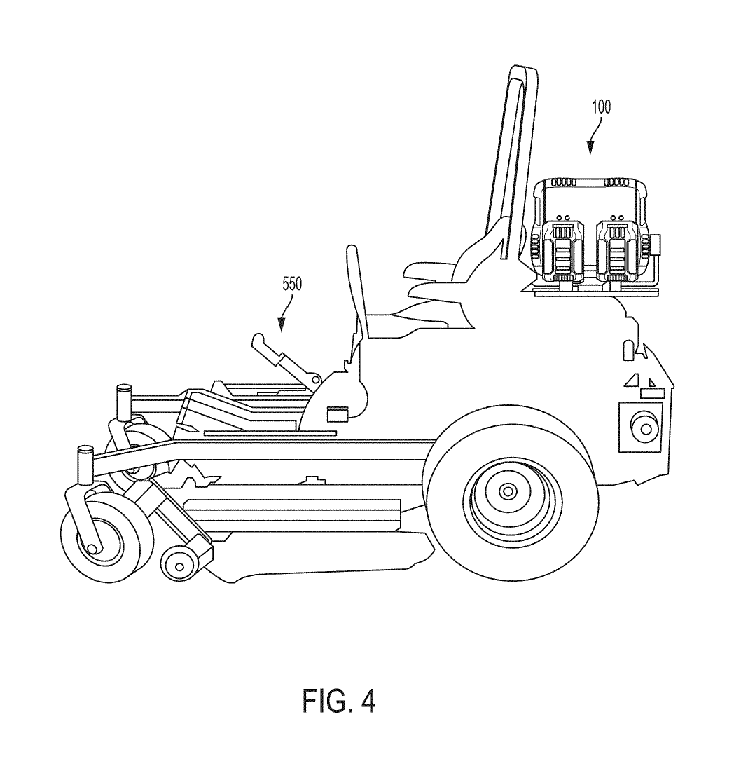

FIG. 4 is an example illustration of the battery pack charger system 100 of FIG. 1 implemented on a riding mower 550. The mower 550 includes a vertical shaft internal combustion engine with a downward facing shaft and an upward facing flywheel. The engine includes a rotating grass screen and an additional screen that is a fixed wire to prevent grass from getting into the flywheel and fan system. The mower 550 is modified simply by removing the rotating grass screen and the additional screen. In this manner, only very minor modification is made to the mower to accommodate the battery pack charger system 100.

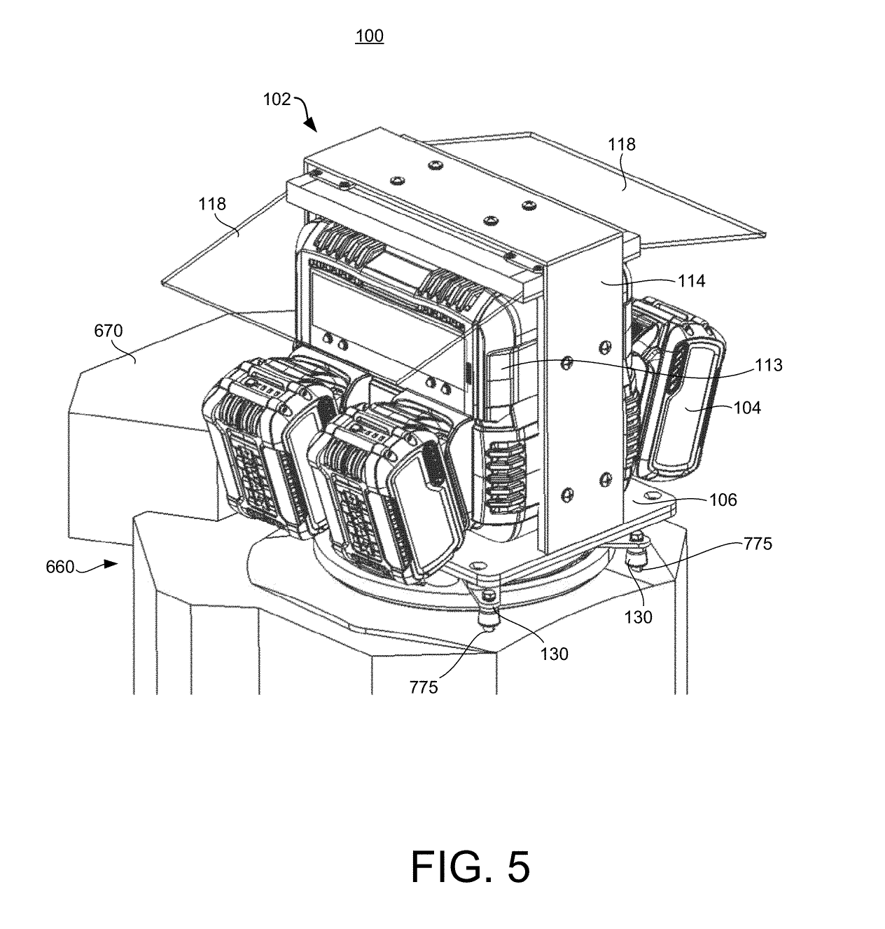

In this example, the battery pack charger system 100 is coupled to the flywheel and fan system of the mower 550 engine, as described and illustrated in more detail below with respect to FIGS. 5-17. The battery pack charger system 100 is attached over the open cavity of the flywheel and fan system with the adapter bracket 112 being coupled to the center of the flywheel and fan cavity. The adapter bracket 112 sits in the cavity inside the blades of the fan, which are on the outside perimeter of the fan. The battery pack charger system 100 is aligned with the top of the vertical shaft flywheel where it is in line with and overtop of the flywheel.

In this example, the battery pack charger system 100 maintains a low profile as it sits behind the mower seat and above the mower engine. While FIG. 4 illustrates one example implementation of the charger system 100 mounted to a mower 550, the battery pack charger system 100 may be mounted to other mowers and mower types including mowers other than riding mowers. For example, the battery pack charger system 100 may be mounted on a mower with a horizontal shaft engine instead of a vertical shaft engine, as illustrated in these examples.

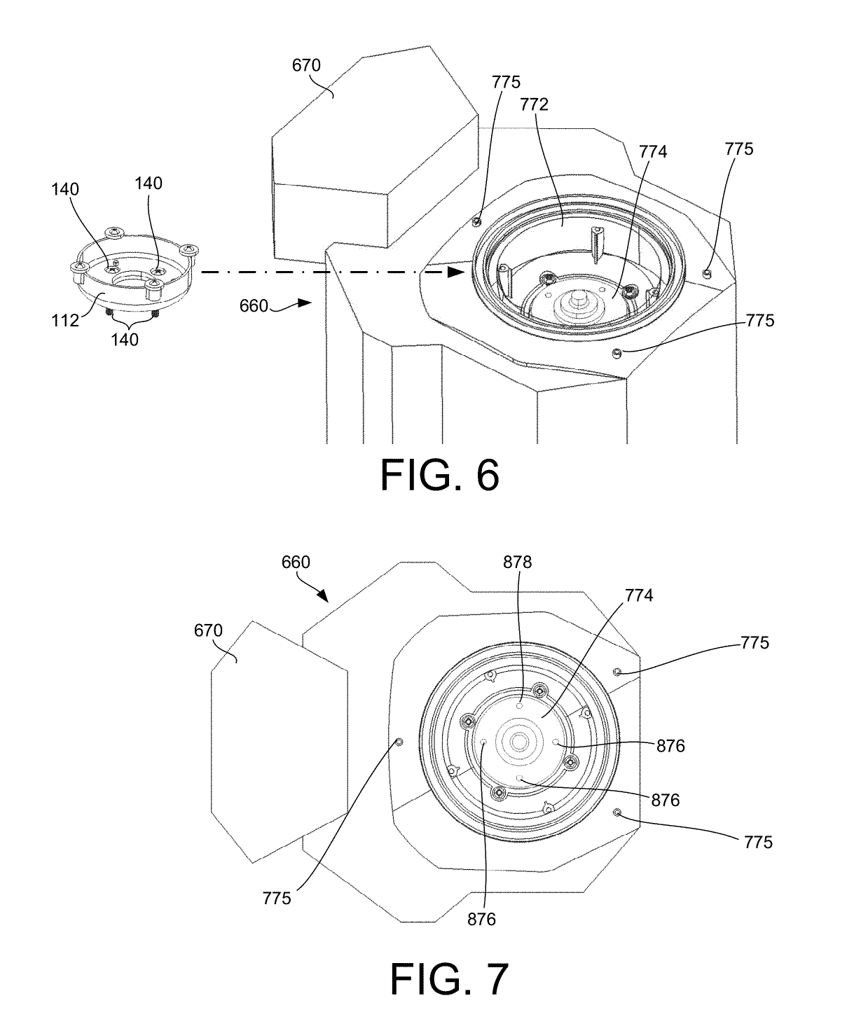

FIG. 5 is a perspective view of the battery pack charger system 100 of FIG. 1 coupled to an internal combustion engine 660, also referred to interchangeably throughout as engine 660. In this example, the battery pack charger system 100 including the charger 102 is mounted to the engine 660. Also illustrated in this example is an air filter 670, which may be a component of the engine for the mower. The battery pack charger system 100 sits above the engine 660 directly in-line and above the flywheel of the engine 660. The battery pack charger system 100 sits next to and behind the air filter 670. The charger 102 is coupled to the engine 660 in the engine shroud holes 775 (2 holes are seen in FIG. 5, but three holes are seen in FIGS. 6-11) using the multiple repositionable arms 130 of the charger mounting bracket 108. The alternator 110 and adapter 112 (not shown in this figure) are attached to the flywheel of the engine 660.

FIG. 6 is a perspective view of the internal combustion engine 660 of FIG. 5 with an uninstalled adaptor bracket 112 of the battery pack charger system. FIG. 7 is a top view of the internal combustion engine 660 of FIG. 5 without the battery pack charger system. Referring to FIGS. 6 and 7, the air filter 670 is attached to the engine 660. In this example, a grass catcher or other cover has been removed from the engine 660 to enable the battery pack charger system to be mounted to the engine 660. In general, the only modification that may be needed to make to the mower is to remove any engine cover or flywheel cover in order to expose the fastener holes used by the cover or grass catcher on the engine shroud.

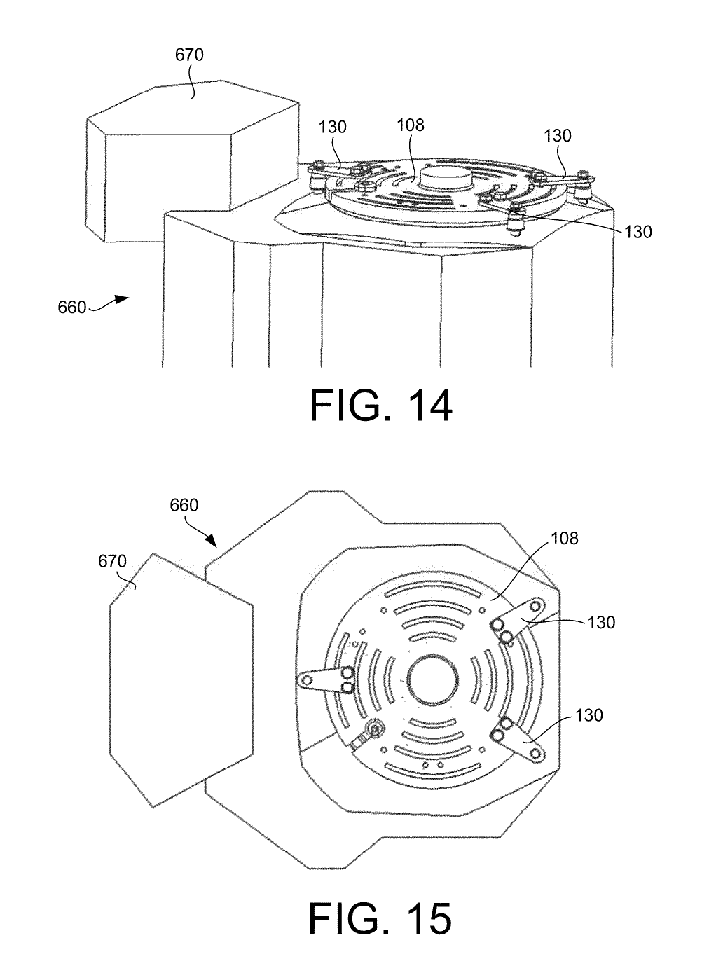

The engine 660 includes a fan 772 and a flywheel 774. The flywheel 774 includes multiple flywheel mounting holes 876 into which the fasteners 140 of the adapter bracket 112 of the battery pack charger system will be secured. The engine 660 also includes shroud holes 775 to which the repositionable arms 130 of the battery pack charger system mount, as illustrated in more detail below in FIGS. 14 and 15. In this example, the engine 660 includes four flywheel mounting holes 876. However, other types of engines may include a different number and/or different positioning of the flywheel mounting holes 876. As discussed above, different adapter brackets may be used depending on the different type of engines and flywheel geometries.

FIG. 8 is a perspective view of an adapter bracket 112 of FIG. 1 installed in the engine 660 of FIG. 5 and an uninstalled alternator 110. FIG. 9 is a top view of the adapter bracket 112 installed in the engine 660 of FIG. 5. In the illustrations of FIG. 8 and FIG. 9, the adapter bracket 112 is shown as inserted into the flywheel of the engine 660. In FIG. 8, the adapter is shown next to the engine 660 and also as it is inserted into the engine. The fasteners 140 on the adapter bracket 112 are inserted into the flywheel mounting holes 876. As mentioned above, the adapter bracket 112 may vary based on a particular engine model.

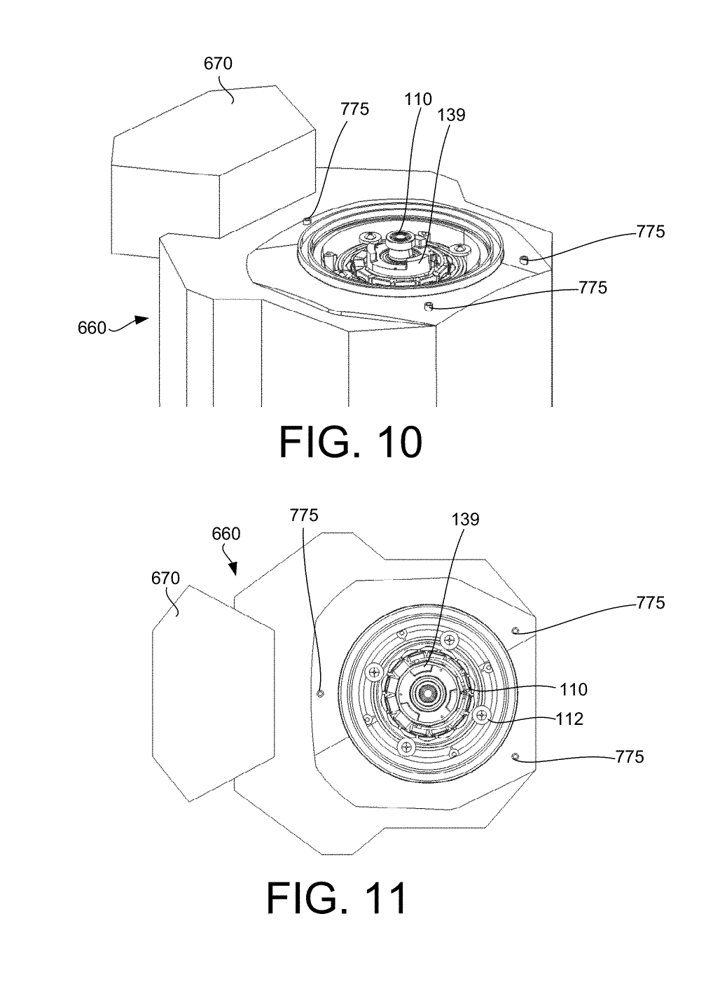

FIG. 10 is a perspective view of the alternator 110 coupled with the adapter bracket 112 and installed in the engine 660 of FIG. 5. FIG. 11 is a top view of the alternator 110 coupled with the adapter bracket 112 and installed in the engine 660 of FIG. 5. FIG. 10 illustrates the combined alternator 110 and adapter bracket 112 as coupled to the flywheel of the engine 660. The alternator 110 may include one or more keying features (not shown) to prevent the alternator 110 from slipping within the adapter bracket 112. As discussed above, the fasteners 140 on the adapter bracket 112 are inserted into the flywheel mounting holes 876. In operation, the rotation of the flywheel 774 also rotates the installed adapter bracket 112 and the rotor component 134 of the alternator 110. The coupling 139 of the stator component 136 is held stationary in the bearing holder 132 of the charger mounting bracket 108. The rotation of the flywheel 774 by the engine 660 causes the rotor component 134 of the alternator 110 to rotate relative to the stationary stator component 136 and generate an electrical charge that is then used to provide power to the charger 102.

FIG. 12 is a view of a top of a charger mounting bracket 108 of FIG. 1. FIG. 13 is a view of a bottom of the charger mounting bracket 108 of FIG. 12. As discussed above, the charger mounting bracket 108 includes multiple openings 126 and multiple repositionable arms 130. The repositionable arms 130 may be secured through one of the openings 126 to align with a particular engine shroud holes 775. In this manner, no modifications need to be made to the engine shroud because the existing engine shroud holes 775 are used to secure the charger mounting bracket 108 to the engine 660. The charger mounting bracket 108 also includes a bearing holder 132, as discussed above.

As illustrated in FIG. 13, the charger mounting bracket 108 includes a compliance element 1407. The compliance element 1407 mates with the coupling 139 of the alternator 110. As discussed above, the coupling 139 is held fixed within the bearing holder 132 such that the stator component 136 does not rotate when the rotor component 134 of the alternator 110 rotates. The compliance element 1407 may be made of a rubber material to dampen vibrations caused by the mower and to assist with any alignment issues.

FIG. 14 is a perspective view of the charger mounting bracket 108 of FIG. 12 coupled to the engine 660 of FIG. 5. FIG. 15 is a top view of the charger mounting bracket 108 of FIG. 12 coupled to the engine 660 of FIG. 5. FIGS. 14 and 15 illustrate the mounting of the charger mounting bracket 108 to the engine 660 by fastening the repositionable arms 130 to the engine shroud holes 775.

FIG. 16 is a perspective view of a charger seating bracket 106 of FIG. 1 coupled to the engine 660 of FIG. 5. FIG. 17 is a top view of the charger seating bracket 106 of FIG. 1 coupled to the engine 660 of FIG. 5. FIGS. 16 and 17 illustrate the mounting of the charger seating bracket 106 to the engine 660.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

1. A battery pack charger system comprising:
a charger having one or more receptacles for charging one or more removable battery packs,
a mount for mounting the system to a rotating component of an engine.

2. The battery pack charger system, as recited in claim 1, further comprising:
an alternator that is electrically coupled to the charger and that is mechanically coupled to the rotating component of the engine to generate and provide electrical power to the charger.

3. The battery pack charger system, as recited in claim 2, further comprising:
an adapter bracket that is mechanically coupled to the charger, the adapter bracket is configured to receive the alternator and to mechanically couple the alternator to the rotating component of the engine.

4. The battery pack charger system, as recited in claim 3, wherein the adapter bracket is received in a flywheel of the engine.

5. The battery pack charger system, as recited in claim 1, wherein the rotating component of the engine includes a flywheel of a mower engine and the charger is mounted to the flywheel.

6. The battery pack charger system, as recited in claim 2, wherein the alternator is a brushless alternator.

7. A battery pack charger system comprising:
a charger having one or more receptacles for charging one or more removable battery packs; and
a charger mounting bracket coupled to the charger, the charger mounting bracket mounting the charger to one or more engine shroud holes of an engine.

8. The battery pack charger system, as recited in claim 7, further including an alternator that is electrically connected to the charger and that is coupled to the charger mounting bracket, the alternator generating electrical power for delivery to the charger.

9. The battery pack charger system, as recited in claim 8, further including an adaptor bracket for receiving the alternator, where the adaptor bracket is received in a flywheel of an engine and imparts rotational motion from the flywheel to the alternator.

10. The battery pack charger system, as recited in claim 7, wherein the removable battery packs are lithium-ion battery packs for providing power to cordless devices.

11. The battery pack charger system, as recited in claim 7, wherein the charger mounting bracket includes one or more slots.

12. The battery pack charger system, as recited in claim 7, wherein the alternator includes a stator component and a rotor component, where the stator component is held stationary by the charger mounting bracket and the rotor component rotates with the adaptor bracket and the flywheel relative to the stator component.

13. The battery pack charger system, as recited in claim 7, further comprising a bracket and a charger seating bracket, where the bracket secures the charger to the charger seating bracket and the charger seating bracket secures the charger to the charger mounting bracket.

14. The battery pack charger system, as recited in claim 13, wherein the bracket includes one or more covers that are hingedly attached to the bracket to cover and protect the charger.

15. A battery pack charger system comprising:
a charger having one or more receptacles for charging one or more removable battery packs,
a mount for mounting the system to a primary rotating element of a primary mover.

16. The battery pack charger system, as recited in claim 15, further comprising:
an alternator that is electrically coupled to the charger and that is mechanically coupled to the primary rotating element of the primary mover to generate and provide electrical power to the charger.

17. The battery pack charger system, as recited in claim 16, further comprising:
an adapter bracket that is mechanically coupled to the charger, the adapter bracket is configured to receive the alternator and to mechanically couple the alternator to the primary rotating element of the primary mover.

18. The battery pack charger system, as recited in claim 16, further comprising a bracket and a charger seating bracket, where the bracket secures the charger to the charger seating bracket and the charger seating bracket secures the charger to the mount.

19. The battery pack charger system, as recited in claim 18, wherein the bracket includes one or more covers that are hingedly attached to the bracket to cover and protect the charger.
